(19) United States
(12) Patent Application Publication
(10) Pub. No.: US 2003/0004001 A1
(43) Pub. Date: Jan. 2, 2003

(54) Simplified driveline

(76) Inventors: Dale K. Bell, Troy, MI (US); John L. Bennett, Fraser, MI (US); Ronald N. Brissette, Lake Orion, MI (US); Michael E. Johnson, Rochester, MI (US); David K. Platner, Shelby, MI (US); Tom Sanko, Troy, MI (US); Jyh-Chiang Wang, Macomb, MI (US)

Correspondence Address: CARLSON, GASKEY & OLDS, P.C., 400 WEST MAPLE ROAD, SUITE 350, BIRMINGHAM, MI, 48009, US

(21) Appl. No.: 09/897,209

(22) Filed: Jul. 2, 2001

(51) Int. Cl. F16D 3/52; F16D 3/56; F16D 3/64; F16D 3/72; F16D 3/76; F16D 3/78

(52) U.S. Cl. 464/75

(57) ABSTRACT

A driveline assembly including first and second members disposed along an axis and an intermediate member engaged to the first and second members along the axis such that the first, second, and intermediate members move axially relative to each other. The first and second members include an interconnection with the intermediate member to transmit torque from the first member through the intermediate member to the second member. The interconnection between the members is formed by interlocking profiles disposed on the outer diameter of the first and second members that corresponds to an interlocking profile on the inner diameter of the intermediate member. The interconnection between the first and second members with the intermediate member includes a sleeve to substantially fill any gaps to prevent relative rotation between the members.

### BACKGROUND OF THE INVENTION

This invention relates to a driveline assembly for transmitting torque between a power source and a drive member.

Typically, a driveline for a motor vehicle includes a shaft extending along an axis between a transmission and a differential of a drive axle. Each end of the shaft includes a yoke that forms one portion of a U-joint. The U-joint allows movement of the shaft member to accommodate movement of the drive axle due to road imperfections.

Typically, a shaft or driveline is designed to further accommodate movement of the drive axle. The U.S. Pat. No. 5,951,402 discloses a driveline assembly to accommodate axial movement between the transmission and the drive axle. The driveline includes a male member mated to a female member both disposed about an axis. The male member and the female member include thin walled tubes that define inner and outer interlocking profiles that are engaged to one another to transmit torque and accommodate axial movement. A gap between interlocking profiles is filled with an elastomeric material to prevent vibration and backlash. The elastomeric compound is injected into the gap at a high temperature in a fluid state, and shrinks as it solidifies and cools. The resulting gap between the seal and the corresponding interlocking profiles provides sufficient clearance to allow axial movement while substantially preventing relative rotational movement between male and female members. However, this assembly includes only one axially movable joint, thereby limiting application. Further, fabrication of such a driveline with this method requires that the mated parts remain together as a unique matched set, thereby adding to manufacturing expense and complexity.

For these reasons, it is desirable to provide a simplified driveline including additional movable joints in a simplified configuration to provide increased application opportunities and a simplified fabrication method that does not depend on unique matched sets.

### SUMMARY OF THE INVENTION

The invention is a driveline assembly for transmitting rotation from a power source to a driven member of a motor vehicle.

The driveline assembly includes a first member having a yoke fixed to one end and a second member having a yoke fixed to one end. An intermediate member engages both the first and second members at an end opposite the yoke. The members are interconnected to transmit rotational torque. The members are interconnected along a longitudinal axis such that each member may move axially relative to the other members. Each of the members are matingly engaged by way of interlocking profiles.

In one embodiment of the subject invention, each of the first and second members include a first end having a yoke that mates to a conventional U-joint, and a second end including the interlocking profiles. Each of the first and second members including the yoke are interchangeable. The first and second members include an outer diameter with the interlocking profile to interconnect to an interlocking profile on an inner diameter of the intermediate member. In other words, the first and second members are male members that interconnect with both ends of the intermediate member, such that the first and second members can accommodate movement along the axis to form a three-piece assembly.

The assembly includes a sleeve that is disposed between the outer diameter of the first and second members and the inner diameter of the intermediate member. The mating shapes fit such that a gap between interlocking profiles is minimized to prevent backlash and vibration. An elastomeric material at a high temperature fills the gap between inner and outer interlocking profiles. Once the elastomeric material has cooled it will shrink, thereby providing a custom fit between parts that substantially reduces backlash between the members while still providing for the axial movement of the members relative to one another.

In another embodiment, the first and second members include yokes attached at one end. The other end of each of the first and second members is a thin walled tube that defines an inner diameter that engages an outer diameter of the intermediate member. The first and second members comprise the female members and engage the male or intermediate member. In this embodiment, the elastomeric sleeve fills the gap between the interlocking profiles of the members.

In another embodiment, only first and second members are used. One of the first and second members interconnects within the other member to form a two-piece assembly.

The invention also includes a method of installing the sleeve disposed within the interface between the first, second and intermediate members. The method includes the steps of assembling the first, second and intermediate members for transmitting torque along a longitudinal axis, injecting a elastomeric compound between the members, and cooling the elastomeric compound such that the elastomeric compound shrinks a predetermined amount to allow for sliding movement of the members along the axis. In this embodiment, the members become a unique matched set.

In another embodiment of the method instead of individually fabricating matched sets, a master die representing a nominally dimensioned mating member is used. A mating part mates to the master and elastomeric material is injected between the master and the mating part such that upon cooling of the elastomeric material the seal is adhered to the mating part and becomes ready for assembly. This method eliminates the need for matched sets because all mating parts or members are interchangeable.

In the foregoing embodiments, the elastomeric material is injected to form the about the entire circumference of the interconnecting member. However, in an additional embodiment, the elastomeric material is injected in discrete locations about the circumference of the interconnecting members. The method and assembly of the subject invention provides a simplified driveline component that accommodates axial movement of the driveline.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is perspective view of a driveline assembly;

FIG. 2 is a perspective view of another embodiment of the driveline assembly,

FIG. 3 is perspective view of another embodiment of the subject invention;

FIG. 4 is a cross-section of the subject driveline showing the sleeve;

FIG. 5 is a cross-section of the elastomeric material disposed at discrete locations between interlocking profiles,

FIG. 6A is a cross section of a master die having an interlocking profile about an outer diameter; and

FIG. 6B is a cross section of a master die having an interlocking profile within an inner diameter.

### DETAILED DESCRIPTION OF THE PREFERRED EMBODIMENT

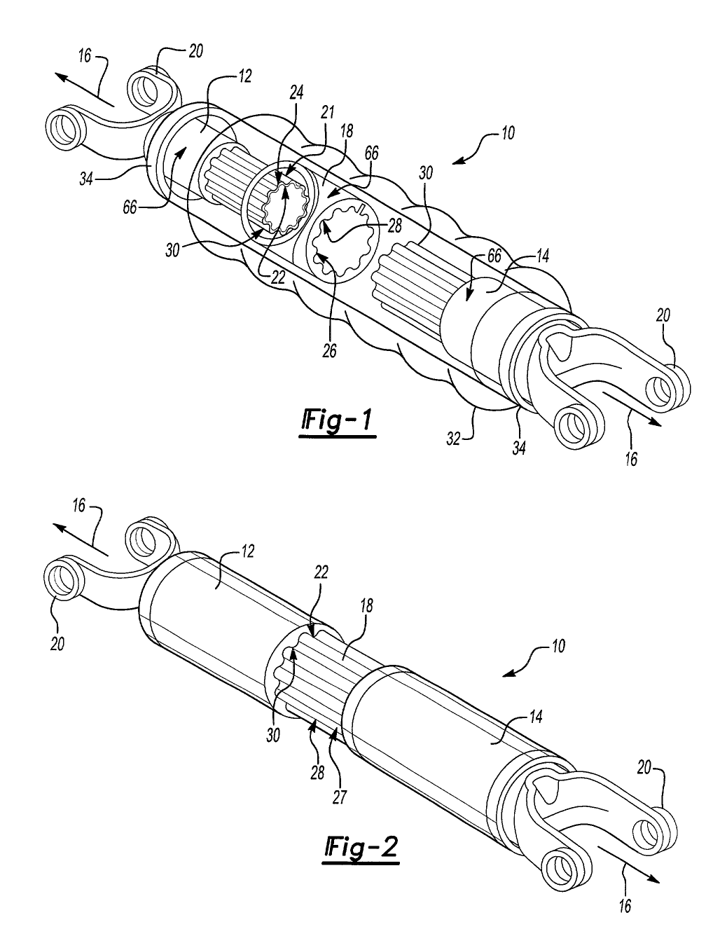

Referring to the Figures, wherein like numerals indicate like or corresponding parts throughout the several views, the subject invention is a driveline assembly for transmitting power from a power source to a drive axle and is generally shown at 10 in FIG. 1. The assembly 10 includes first and second members 12,14 disposed along a longitudinal axis 16. An intermediate member 18 is engaged to both the first and second members 12,14. Each of the first and second members 12,14 include ayoke 20. The yoke 20 maybe an integrally formed part of the first and second members 12,14. In such an assembly the yoke 20 and the member 12, 14 would be a forging such that the yoke and the member 12, 14 become a one-piece assembly. In this manner the yoke 20 and member 12,14 integral member become interchangeable. The yoke 20 may also be a separate assembly attached during assembly of the driveline assembly 10 by any means of securing the yoke 20 to the driveline 10 as is known by a worker skilled in the art would be within the scope of this invention.

Preferably, the first and second members 12,14 are fabricated from a thin walled tube 21 that defines an inner and an outer diameter 22,24. Although preferably a thin walled tube is used thick walled tube or other shapes as are known by a worker knowledgeable in the art are within the scope of this invention. The intermediate member 18 disposed between the first and second members 12,14 includes an inner diameter 26 with an interlocking profile 28. The first and second members 12,14 include an interlocking profile 30 on the outer diameter 24 that interconnects with the interlocking profile 26 of the intermediate member 18. The interconnection between the first and second members 12,14 with the intermediate member 18 provides for relative axial movement between the three members 12,14,18. The driveline 10 can also includes a protective boot 32 secured by clamps 34 to prevent the introduction of contaminants into the interconnections.

Referring to FIG. 2, another embodiment of the driveline is disclosed. In this embodiment, the first and second members 12,14 include the interlocking profile 30 on the inner diameter 22 and the intermediate member 18 includes the interlocking profile 28 on the outer diameter 27. This configuration provides the same relative axial movement of the member as was shown in the previous embodiment.

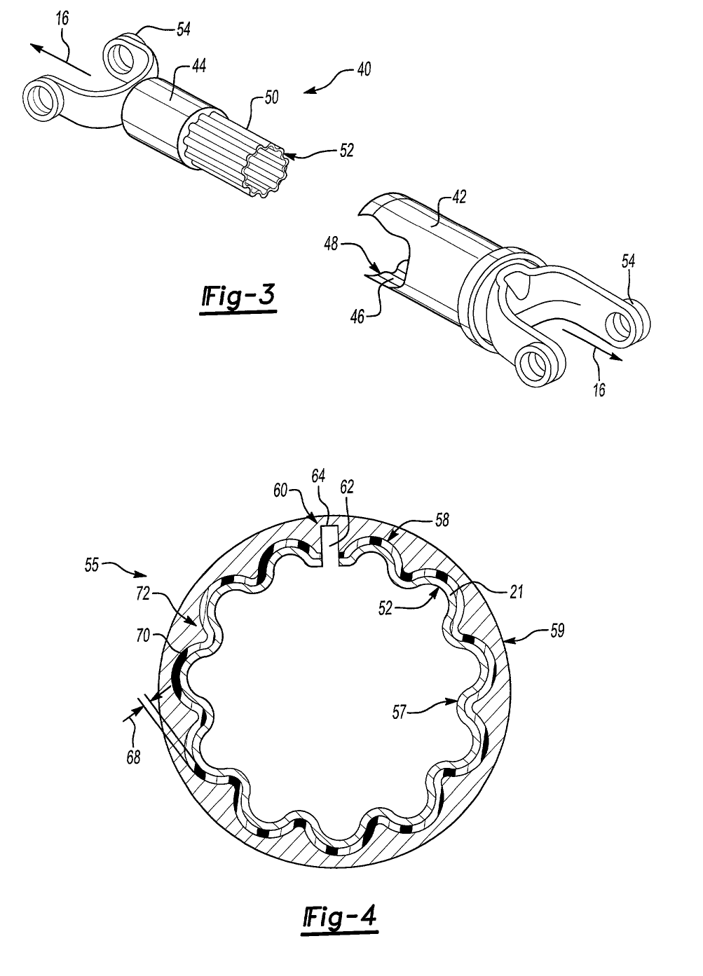

Referring to FIG. 3, another embodiment of the invention includes a first member 42 and a second member 44 disposed along the axis 16 to form a two-piece assembly 40. The first member 42 includes an inner diameter 46 with an interlocking profile 48 and the second member 44 includes an outer diameter 50 with an interlocking profile 52 to engage the interlocking profile 48 of the first member 42. Member 44 can be of a solid or hollow construction. Each of the members 42,44 includes a yoke 54. Preferably, a forging process integrally forms the yoke 54 and the second member 44. The interlocking profile 48 would then be formed in the second member 44 by a secondary process as is known by a worker skilled in the art.

Referring to FIG. 4, interlocking profiles 55 are of the same configuration as those described in the previous embodiments. Preferably, the interlocking profile is composed of plurality of alternating male and female teeth 56,58 formed within the thin walled tube 21. Although, the preferred embodiment includes a plurality of interlocking male and female teeth 56,58, it is within the contemplation of this invention that any type of interlocking shape as is known in the art can be used such as splined or rhombic shapes.

Preferably, the interlocking profiles 55 include an alignment feature 60 to control the alignment of the yokes 20, 54 disposed on distal ends of the first and second members 12,14 and 42,44 such that the yokes 20, 54 properly align with mating components of the transmission and the drive axle. The alignment feature 60 shown in FIG. 4 is the shape of a tab 62 and slot 64, however other methods as are known to a worker skilled in the art are within the scope of this invention. Further, as best shown in FIG. 1, the members 12,14, 18 may include alignment markings 66 to indicate the proper radial position for assembly.

The interlocking profiles 55 allow for axial movement while preventing or eliminating relative rotational movement between the members. Typically, such a connection requires tightly held tolerances and selective fit assembly. The driveline of the subject invention includes larger tolerances to reduce manufacturing costs. The larger tolerance between parts creates a gap 68 disposed between interlocking profiles 55 of the members. The existence of gap 68 between the interlocking profiles 55 can allow for relative rotational movement between the members resulting in backlash and vibration of the driveline. However, some gap 68 is needed to allow for the relative axial motion between the members.

The subject invention includes a sleeve 70 disposed within the gap 68 to fill excessive space between the interlocking profiles 55 that can cause backlash. Preferably, the sleeve 70 is fabricated from an elastomeric material injected between the interlocking profiles 55. Preferably, the elastomeric material is a urethane. It is within the contemplation of this invention that any material known to a worker skilled in the art may be used. The sleeve 70 is formed entirely about a circumference 72 of the interlocking profile and adheres and conforms to any size gap or imperfection. Preferably, the elastomeric material is injected between the interlocking profiles 55 at a high temperature to completely fill the gap 68. The elastomeric material cools and shrinks a predetermined amount to provide sufficient clearance to allow axial movement between interconnected members, and prevent substantially all relative rotational movement.

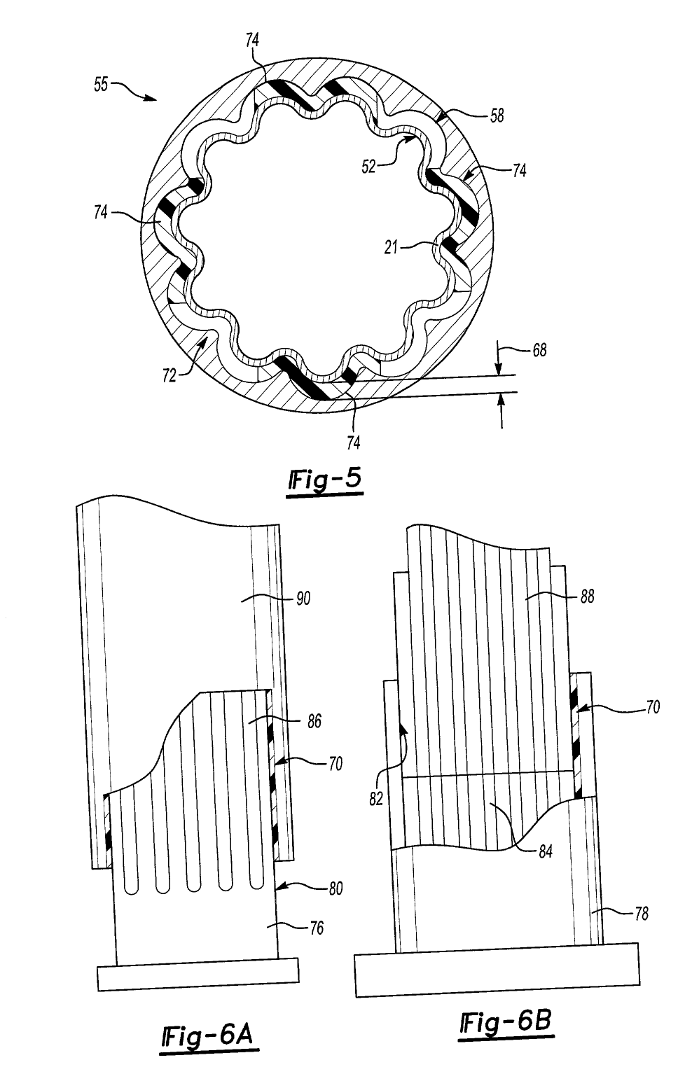

Referring to FIG. 5, another embodiment is disclosed where the elastomeric material does not extend entirely about the circumference 72 of the interlocking profiles 55. In this embodiment, the elastomeric material is disposed in discrete locations 74 within the gap 68 and about the interlocking profiles 55. This is just one possible configuration of forming the elastomeric material in a less then full 360 degrees configuration and a worker skilled in the art would understand variations that are within the contemplation of this invention.

The subject invention includes a method of fabricating a driveline assembly 10 having a sleeve 70. To simplify discussion of the method reference is made to first and second members in reference to any of the members 12,14,18, 42,44 described in any of the previous embodiments. Further, interlocking profiles 55 refers to any connection between the members 12,14,18, and 42,44 in any of the embodiments described above. The method includes the steps of interconnecting a first member to a second member by way of an interlocking profile 55 such that torque is transmitted between members along the axis 16. The gap 68 between the interlocking profiles is filled with an elastomeric material. The elastomeric material is introduced at a temperature that allows the elastomeric material to freely flow and fill the gap 68 and any imperfections disposed between the interlocking profiles. The elastomeric material cools as it solidifies such that the elastomeric material shrinks, thereby providing clearance between the interlocking profiles to limit relative rotational movement between the first and second members.

In a first embodiment of the method a unique matched set of driveline members are fabricated upon the cooling and solidification of the elastomeric materials. The unique parts must be used as a set in order to function properly and allow axial movement while substantially eliminating any relative rotational movement.

Referring to FIGS. 6A and 6B, a master die 76 including interlocking profiles 86 about an outer diameter 80 and a master die 78 including an interlocking profile 84 within an inner diameter 82 are shown. The interlocking profiles 84,86 are of a predetermined dimension to mate to a member 88 to be used in the driveline assembly. The member 88 having the interlocking profile on an outer diameter will interconnect to the master die 78 having the corresponding interlocking profile 84 on the inner diameter 82, and a member 90 having an interlocking profile on the inner diameter will interconnect to the master die 76 having the interlocking profile 86 on the outer diameter 80. This method provides for multiple duplicate members 88 having interlocking profiles about the outer diameter and multiple duplicate members 90 having interlocking profiles about the inner diameter to be assembled without the need to maintain unique matched sets.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason, the following claims should be studied to determine the true scope and content of this invention.

What is claimed is:

1. A driveline assembly comprising;
a first and second member disposed along an axis, each of said first and second members including a yoke,
a intermediate member engaged to said first and second members along said axis such that said first, second, and intermediate members move axially relative to each of said other members,
said first and second member include an interconnection with said intermediate member to transmit torque from said first member through said intermediate member to said second member,
said interconnection between said first and second members with said intermediate member including a sleeve to substantially fill any gaps within said interconnection.

2. The assembly of claim 1, wherein said first and second members include an inner diameter having an interlocking profile and said intermediate member includes an outer diameter with an interlocking profile to interconnect with said interlocking profile of said first and second members.

3. The assembly of claim 1, wherein said first and second members include an outer diameter having an interlocking profile and said intermediate member includes an inner diameter with an interlocking profile to interconnect with said interlocking profile of said first and second members.

4. The assembly of claim 3, wherein said first and second members and said yoke are formed as a one-piece integral part.

5. The assembly of claim 4, wherein said integral part is forged.

6. The assembly of claim 5, wherein said integral part is solid.

7. The assembly of claim 5, wherein said integral part is hollow.

8. The assembly of claim 1, wherein said each of said members is fabricated from a thin walled tube defining said interconnection between said first, second and intermediate members.

9. The assembly of claim 8, wherein said interconnection is formed from a plurality of male and female teeth formed within said thin walled tube.

10. The assembly of claim 1, wherein said sleeve is fabricated from an elastomeric material.

11. The assembly of claim 1, wherein said sleeve is formed entirely about a circumference of said thin walled tube.

12. The assembly of claim 1, wherein said sleeve is formed in discrete locations about said thin walled tube.

13. The assembly of claim 1, wherein said interconnection between said members includes an alignment feature to align said yokes.

14. A driveline assembly comprising;
a first member disposed along an axis and including a yoke,
a second member including an integrally formed yoke engaged to said first member along said axis such that said first and second members move axially relative to each other,
said first and second member including an interconnection to transmit torque from said first member to said second member,
said interconnection between said first and second members includes a sleeve to substantially fill any gaps within said interconnection.

15. The assembly of claim 14, wherein said first member includes an inner diameter having an interlocking profile and said second member includes an outer diameter with an interlocking profile to interconnect with said interlocking profile of said first member.

16. The assembly of claim 15, wherein said integrally formed yoke and said second member are fabricated by forging.

17. The assembly of claim 16, wherein said member is solid.

18. The assembly of claim 17, wherein said member is hollow.

19. The assembly of claim 14, wherein each of said members is fabricated from a thin walled tube defining said interlocking profile between said first and second members.

20. The assembly of claim 19, wherein said interlocking profile is formed from a plurality of male and female teeth formed within said thin walled tube.

21. The assembly of claim 14, wherein said sleeve is fabricated from an elastomeric material injected between said members.

22. The assembly of claim 14 wherein said sleeve is disposed entirely about a circumference of said thin walled tube.

23. The assembly of claim 14, wherein said sleeve is disposed in discrete locations about interlocking profiles.

24. The assembly of claim 14, wherein said interconnection between said members includes an alignment feature to align said yokes.

25. A method of manufacturing a driveline, said method comprising said steps of;
interconnecting first and second members having interlocking profiles to transmit torque along an axis, said members movable axially along said axis, and including a gap between interlocking profiles,
introducing an elastomeric material to fill said gap between said interlocking profiles,
cooling said elastomeric material upon which said elastomeric material shrinks to provide clearance between said interlocking profiles to limit relative rotational movement between said first and second members.

26. The method of claim 25, wherein said first and second members become a matched set.

27. The method of claim 25, wherein said first members is a master die having an interlocking profile, and said interconnecting step further includes connecting said second member to said master die such said second member will interconnect with any first member.

28. The method of claim 25, wherein said elastomeric material is formed entirely about said interlocking profiles of said first and second members.

29. The method of claim 25, wherein said elastomeric material is formed at discrete locations about said interlocking profiles of said first and second members.
